(19) United States
(12) Patent Application Publication
(10) Pub. No.: US 2015/0340122 A1
(43) Pub. Date: Nov. 26, 2015

(54) THE INVENTION RELATES TO AN ELECTRICAL CABLE COMPRISING A CABLE COVER

(71) Applicant: DSM IP ASSETS B.V., Heerlen (NL)

(72) Inventors: Beert Jacobus KEESTRA, Echt (NL); Angelika SCHMIDT, Echt (NL)

(21) Appl. No.: 14/652,373

(22) PCT Filed: Dec. 13, 2013
(86) PCT No.: PCT/EP2013/076472

§ 371 Date: Jun. 15, 2015

(30) Foreign Application Priority Data
Dec. 18, 2012 (EP) 12197786.2

(51) Int. Cl. H01B 3/30; H01B 3/44; H01B 3/42

(52) U.S. Cl. CPC H01B 3/308; H01B 3/421; H01B 3/448

(57) ABSTRACT

Electrical cable comprising a cable cover of a polymer composition, having a diameter of below 7 mm, which polymer composition contains a matting agent and a mold release agent and/or an external lubricant.

Electrical cables normally contain a cable cover of a polymer composition. Electrical cables and wires with all kind of diameter exist, used for all kind of applications. Wires generally comprise a layer of a polymeric composition as insulation. The wires are bundled with two or more wires in a cable and surrounded with the polymeric cover. It is also possible that the cable contains insulated wires that are molten together. In that case the insulation of the wires is the cover of the cable.

A problem, with especially cables having a thinner diameter, of below 7 mm, is that the cables get entangled during use and that it is difficult to get the cables disentangled again.

Aim of the invention is to provide a cable that can easily be disentangled.

Surprisingly such a cable is provided if the cover of the cable consists of a polymer composition containing a matting agent and a mold release agent and/or an external lubricant.

Furthermore a cable cover that has an appealing silky appearance is obtained. The appealing silky appearance is highly aesthetic, gives a nice soft feeling to the cable cover made from the composition and also provides a slippery surface.

The polymer composition of the cover of the cable according to the invention may contain all kind of thermoplastic polymers that are normally used for the production of cable covers. The invention is especially valuable if the polymer composition contains a thermoplastic elastomer. Especially preferred thermoplastic elastomers include a thermoplastic copolyester elastomer, a thermoplastic copolyamide elastomer, a thermoplastic polyurethane elastomer and a styrene ethylene butylene styrene copolymer (SEBS). It is possible that the composition contains one, two or even three thermoplastic elastomers chosen form the group above.

Thermoplastic polyurethane elastomers may be obtained by the condensation of diisocyanates with short-chain diols and long chain diols, for example polyester or polyether diols. The polymer chain segments comprising the monomer units of the diisocyanates and the short-chain diols are the crystalline hard segments and the chain segments derived from the long chain diols are the soft segments. The diisocyanate most commonly used is 4,4′-diphenylmethane diisocyante (MDI). Commonly used short-chain diols include ethylene glycol, 1,4-butanediol, 1,6-hexanediol and 1,4-di-β-hydroxyethoxybenzene.

The copolyester elastomers and copolyamide elastomers are thermoplastic polymers with elastomeric properties comprising polyester hard segments or polyamide hard segments, and soft segments derived from another polymer. The polyester hard segments in the copolyester elastomers are generally composed of monomer units derived from at least one alkylene diol and at least one aromatic or cycloaliphatic dicarboxylic acid. The polyamide hard segments of the copolyamide elastomers are generally composed of monomer units from at least one aromatic and/or aliphatic diamine and at least one aromatic or aliphatic dicarboxylic acid, and or an aliphatic amino-carboxylic acid.

The hard segments typically consist of a polyester or polyamide having a melting temperature or glass temperature, where applicable, well above room temperature, and may be as high as 300° C. or even higher. Preferably the melting temperature or glass temperature is at least 150° C., more preferably at least 170° C. or even at least 190° C. The soft segments typically consist of segments of an amorphous polymer having a glass transition temperature well below room temperature. Preferably the glass temperature of the amorphous polymer is at most
0° C., more preferably at most −10° C. or even at most −20° C. Still more preferably the glass temperature of the soft segments is in the range of −20-−50° C., ort even −30-−60° C.

Suitably, the copolyamide elastomer is a copolyetheramide elastomer. Copolyetheramide elastomers are available, for example, under the trade name PEBAX, from Elf Atochem, France.

Preferably, the thermoplastic elastomer is a copolyester elastomer. Examples of copolyester elastomers include a copolyesterester elastomer, a copolycarbonateester elastomer or a copolyetherester elastomer; i.e. a copolyester block copolymer with soft segments derived from a polyester, a polycarbonate or, respectively, a polyether. Copolyester elastomers are available, for example, under the trade name Arnitel, from DSM Engineering Plastics B.V., The Netherlands.

Suitable copolyesterester elastomers are described, for example, in EP-0102115-B1.

Copolyetherester elastomers have soft segments derived from at least one polyalkylene oxide glycol. Copolyetherester elastomers and the preparation and properties thereof are in the art and for example described in detail in Thermoplastic Elastomers, 2nd Ed., Chapter 8, Carl Hanser Verlag (1996) ISBN 1-56990-205-4, Handbook of Thermoplastics, Ed. O. Otabisi, Chapter 17, Marcel Dekker Inc., New York 1997, ISBN 0-8247-9797-3, and the Encyclopaedia of Polymer Science and Engineering, Vol. 12, pp. 75-117 (1988), John Wiley and Sons, and the references mentioned therein.

The aromatic dicarboxylic acid in the hard segments of the polyetherester elastomer suitably is selected from the group consisting of terephthalic acid, isophthalic acid, phthalic acid, 2,6-naphthalenedicarboxylic acid and 4,4-diphenyldicarboxylic acid, and mixtures thereof. Preferably, the aromatic dicarboxylic acid comprises terephthalic acid, more preferably consists for at least 50 mole %, still more preferably at least 90 mole %, or even fully consists of terephthalic acid, relative to the total molar amount of dicarboxylic acid.

The alkylene diol in the hard segments of the polyetherester elastomer suitably is selected from the group consisting of ethylene glycol, propylene glycol, butylene glycol, 1,2-hexane diol, 1,6-hexamethylene diol, 1,4-butane diol, benzene dimethanol, cyclohexane diol, cyclohexane dimethanol, and mixtures thereof. Preferably, the alkylene diol comprises ethylene glycol and/or 1,4 butane diol, more preferably consists for at least 50 mole %, still more preferably at least 90 mole %, or even fully consists of ethylene glycol and/or 1,4 butane diol, relative to the total molar amount of alkylene diol.

The hard segments of the polyetherester elastomer most preferably comprise or even consist of polybutylene terephthalate segments.

Suitably, the polyalkylene oxide glycol is a homopolymer or copolymer on the basis of oxiranes, oxetanes and/or oxolanes. Examples of suitable oxiranes, where upon the polyalkylene oxide glycol may be based, are ethylene oxide and propylene oxide. The corresponding polyalkylene oxide glycol homopolymers are known by the names polyethylene glycol, polyethylene oxide, or polyethylene oxide glycol (also abbreviated as PEG or PEO), and polypropylene glycol, polypropylene oxide or polypropylene oxide glycol (also abbreviated as PPG or PPO), respectively. An example of a suitable oxetane, where upon the polyalkylene oxide glycol may be based, is 1,3-propanediol. The corresponding polyalkylene oxide glycol homopolymer is known by the name of poly(trimethylene)glycol. An example of a suitable oxolane, where upon the polyalkylene oxide glycol may be based, is tetrahydrofuran. The corresponding polyalkylene oxide glycol homopolymer is known by the name of poly(tretramethylene)glycol (PTMG) or polytetrahydrofuran (PTHF). The polyalkylene oxide glycol copolymer can be random copolymers, block copolymers or mixed structures thereof. Suitable copolymers are, for example, ethylene oxide/propylene oxide block-copolymers, (or EO/PO block copolymer), in particular ethylene-oxide-terminated polypropylene oxide glycol.

The polyalkylene oxide can also be based on the etherification product of alkylene diols or mixtures of alkylene diols or low molecular weight poly alkylene oxide glycol or mixtures of the aforementioned glycols.

Preferably, the polyalkylene oxide glycol is selected from the group consisting of polypropylene oxide glycol homopolymers (PPG), ethylene oxide/polypropylene oxide block-copolymers (EO/PO block copolymer) and poly(tretramethylene)glycol (PTMG), and mixtures thereof. Most preferably PTMG is used.

Also good results are obtained with thermoplastic elastomers containing monomer units of dimerised fatty acids and/or a diamine derived there from. A very strong adhesion is obtained and also a high resistance against fatty acids.

Such dimerised fatty acids acids may be obtained by the dimerisation of a monomeric unsaturated fatty acid and are indicated by dimerised fatty acid.

After the dimerisation reaction the so obtained oligomer mixture is further processed, for example by distillation, to yield a mixture having a high content of the dimerised fatty acid. The double bonds in the dimerised fatty acid may be saturated by catalytic hydrogenation. The term dimerised fatty acid as it is used here relates to both types of these dimerised fatty acids, the saturated and the unsaturated. It is preferred that the dimerised fatty acid is saturated. The dimerised fatty acids preferably contain from 32 up to 44 carbon atoms. Most preferably the dimerised fatty acid contains 36 carbon atoms. The amount of C-atoms normally is an average value, since the dimerised fatty acids normally are commercially available as a mixture.

It is also possible to produce a derivative of the dimerised fatty acid by replacing one or two of the acid groups by an amine group by one of the well known reactions.

Preferably the thermoplastic elastomer contains 40-80 wt. % of polybutylene terephthalate hard segments and between 20 and 60 wt. % of monomer units of dimerised fatty acid and/or a diamine derived therefrom.

Matting agents include talcum and silica particles. The particles preferably have an average size (d₅₀ on weight basis) of between 1 and 10 microns. Talcum is a mineral and is produced and commercially available as a matting agent. Silica particles that are suitable for use as matting agents may be produced in a flame process, to obtain so-called fumed silica products. Preferably the silica particles are obtained in a precipitation process, to obtain so-called precipitated silica. The silica particles that are suitable for use as matting agents are commercially available. Preferably the polymer composition according to the invention contains at least 1 weight % of matting agent, more preferably 2 wt. %, most preferably 3 wt. %. Preferably the polymer composition according to the invention contains at most 10 weight % of matting agent, more preferably at most 8 wt. % most preferably at most 6 wt. %.

A mold release agent is a chemical compound that facilitates the release of a part from a mold, preferably by creating a slip effect between the surface of the part and the surface of the mold cavity. Examples of mold release agents include compounds based on fatty acids, for example metal salts of stearates especially sodium, zinc or calcium stearate or montanate.

An external lubricant is a chemical compound that reduces the pressure in an extruder die, by creating a slip layer between the die wall and the polymer melt. Examples of external lubricants include waxes, for instance polyethylene wax, long chain polyols, for instance the triglyceride of stearic acid.

Preferably eurecamide is used. Preferably the polymer composition according to the invention contains at least 0.1 weight % of mold release agent and/or external lubricant, more preferably 0.2 wt. %, most preferably 0.4 wt. %. Preferably the polymer composition according to the invention contains at most 3 weight % of mold release agent and or external lubricant, more preferably at most 2 wt. % most preferably at most 1.5 wt. %

Often chemical compounds are suitable both to serve as a mold release agent and as an external lubricant.

In a further improved embodiment the polymer composition of the cable cover comprises a plasticizer, preferably from 2 30 wt. %, more preferably from 4-20 wt. %. A cable cover of such a polymer composition becomes less filthy because of sebum. Examples of suitable plasticizers include epoxydised vegetable oil for example epoxydidised soybean oil and epoxydised linseed oil and oligomeric phosphate ester for example resorcinol diphenyl phosphate.

The cables according to the invention may have a diameter between 7 and 4 mm. Good examples of such cables are power cords (AC) for domestic appliances, for example a vacuum cleaner or a computer.

Good results are obtained with cables having a diameter of 2-4 mm. Good examples of such cables include data cables (3-4 mm) and cables (DC) of chargers of for example a lab top or telephone (2-4 mm). Best results are obtained with cables having a diameter below 2 mm, preferably earphone cables, having in general a diameter between 1-1.25 mm.

The invention is further explained in the examples.

### Materials Used

COPE: Thermoplastic copolyester elastomer comprising polybutylene terephthalate hard segments, p-THF soft segments, having a melt flow index (MFI) of 10 grams/10 min.
Kraton™ A 1536, an SEBS copolymer, delivered by Kraton, the USA.
Nipgel™ CX200, a matting agent based on precipitated silica particles, delivered by Tosch Silica Corp. from Japan.
Loxiol™ E spez P, an external lubricant based on eurecamide, delivered by Emery Oleochemicals, Germany.

### Preparation of Polymer Compositions

Dry blends of the polymer compositions according to the examples and the comparative experiments were produced by mixing the components in a tumbler at room temperature. The dry blends are fed to a Werner and Pfleiderer™ corotating twin screw extruder having a screw diameter of 25 mm. The output of the extruder was 25 kg/h, the melt temperature was about 250° C.

### Preparation of the Test Samples

Electrical cables for earphone were extruded, using a standard single screw extruder and die for cable extrusion. The diameter for the cables was 1 mm.

### Testing of Disentangeling

The cables were entangled and thereafter disentangled by hand. The cable according to the example was easy to disentangle, the cable according to the comparative experiment was not.

### COMPARATIVE EXPERIMENT A AND EXAMPLE I

The results are given in table 1.

TABLE 1

| | A | I |
|---|---|---|
| COPE | 65 wt. % | 59.25 wt. % |
| Kraton | 35 wt. % | 35 wt. % |
| Matting agent | | 5 wt. % |
| External lubricant | | 0.75 wt. % |
| Disentangeling | Difficult | Easy |

1. Electrical cable comprising a cable cover of a polymer composition, having a diameter of below 7 mm, wherein the polymer composition contains a matting agent and a mold release agent and/or an external lubricant.

2. Electrical cable according to claim 1, wherein the polymer composition contains a thermoplastic elastomer.

3. Electrical cable according to claim 2, wherein the thermoplastic elastomer is a thermoplastic copolyester elastomer.

4. Electrical cable according to claim 1, wherein polymer composition contains at least 10 weight % of a matting agent.

5. Electrical cable according to claim 1, wherein polymer composition contains at most 10 weight % of a matting agent.

6. Electrical cable according to claim 1, wherein polymer composition contains at least 0.1 weight % of a mold release agent and/or an external lubricant.

7. Electrical cable according to claim 1, wherein polymer composition contains at most 3 weight % of a mold relase agent and/or an external lubricant.

8. Electrical cable according to claim 1, wherein the cable is a power cord, having a diameter of between 7 and 4 mm.

9. Electrical cable according to claim 1 wherein the cable has a diameter of between 3 and 4 mm.

10. Electrical cable according to claim 1, wherein the cable has a diameter of below 2 mm.
